(19) United States
(12) Patent Application Publication
(10) Pub. No.: US 2008/0196296 A1
(43) Pub. Date: Aug. 21, 2008

(54) Fruit-Shaped Fruit Fly Trap

(76) Inventors: Bruce R. Studer, Germantown, WI (US); Tim Jones, Phoenix, AZ (US)

Correspondence Address: James P. Rieke, Esq.;NIKOLAI & MERSEREAU, P.A., Suite 820, 900 Second Avenue South, Minneapolis, MN, 55402-3325, US

(21) Appl. No.: 11/676,792

(22) Filed: Feb. 20, 2007

(51) Int. Cl. A01M 1/14; A01M 1/10

(52) U.S. Cl. 43/114; 43/122; 43/107

(57) ABSTRACT

A fruit fly trap whose exterior shape represents a piece of fruit such as an apple, orange, banana or the like. The trap housing includes a bottom base portion and a top cover portion. The cover contains various holes through which fruit flies can gain access to the interior of the trap. The trap also includes a locking mechanism for securing the base and cover together. Located inside the trap is a natural product attractant stored within the interior of the trap. The construction of the trap is such that the liquid or powder attractant is retained inside the trap so it will not spill out. Also, a disabling adhesive is located on a glueboard insert and/or on the interior walls of the trap. Thus, when fruit flies enter the trap they will get caught in the adhesive or simply die because they cannot escape.

### BACKGROUND OF THE INVENTION

I. Field of the Invention

This invention relates generally to apparatus for use in pest elimination and control, and more particularly to a device for capturing, disabling, and exterminating fruit flies and other insects.

II. Discussion of the Prior Art

For hundreds of years, persons have pursued the development of methods to control insects found in and around homes and businesses. In certain circumstances, this need to manage unwanted pests has specifically related to the elimination and control of fruit flies from areas in which they are a nuisance or particularly harmful. In the past, insect sprays, poisonous substances, and a variety of pest control traps were frequently used to accomplish such tasks. These substances and traps have taken on a variety of shapes and sizes. Unfortunately, many of these methods and devices are unsightly, not well suited for the elimination and control of fruit flies, difficult to use, hazardous, or likely to cause a mess.

Therefore, a new insect control device is needed for attracting and exterminating fruit flies that is effective, non-intrusive, simple and which overcomes the problems experienced in past methods and devices aimed at insect control. The present invention of a fruit shaped fly trap meets these needs.

### SUMMARY OF THE INVENTION

The present invention relates generally to fruit fly traps. The exterior shape of the trap, when assembled, represents a piece of naturally occurring fruit such as an apple, orange, banana or the like. The trap has a housing with a bottom base portion and a top cover portion. In the top portion of the trap housing are various access holes through which the fruit flies can gain entry to the interior chamber of the trap. The trap also includes a locking mechanism for securing the base and cover together.

Located inside the trap is a natural product attractant. This attractant can be a liquid or powder stored within the interior of the trap. The construction of the trap is such that the liquid or powder is retained inside the trap so it will not spill out. Specifically, the powder or liquid can be placed in a small container which allows odors from the liquid or powder to be emitted but still retains the liquid or powder so it does not spill.

Also located on the interior walls of the trap is an adhesive surface. Thus, when fruit flies and insects enter the trap they will get caught in the adhesive or simply die because they cannot escape out of the holes through which they entered the trap.

The foregoing features, objects and advantages of the invention will become apparent to those skilled in the art from the following detailed description of a preferred embodiment, especially when considered in conjunction with the accompanying drawings.

### DESCRIPTION OF THE DRAWINGS

FIG. 1 is an exploded view of the fruit fly trap of the present invention;

FIG. 2 is a perspective view of the fruit fly trap;

FIG. 3 is a front view of the fruit fly trap;

FIG. 4 is a top view of the fruit fly trap;

FIG. 5 is a bottom view of the fruit fly trap;

FIG. 6A is an exploded view of an orange shaped embodiment of the trap;

FIG. 6B is a perspective view of an orange shaped embodiment of the trap;

FIG. 6C is a front view of an orange shaped embodiment of the trap;

FIG. 6D is a top view of an orange shaped embodiment of the trap;

FIG. 6E is a bottom view of an orange shaped embodiment of the trap;

FIG. 7A is an exploded view of a banana shaped embodiment of the trap;

FIG. 7B is a perspective view of a banana shaped embodiment of the trap;

FIG. 7C is a front view of a banana shaped embodiment of the trap;

FIG. 7D is a top view of a banana shaped embodiment of the trap;

FIG. 7E is a bottom view of a banana shaped embodiment of the trap;

FIG. 7F is a rear view of a banana shaped embodiment of the trap;

FIG. 7G is a right side view of a banana shaped embodiment of the trap; and

FIG. 7H is a left side view of a banana shaped embodiment of the trap.

### DESCRIPTION OF THE PREFERRED EMBODIMENT

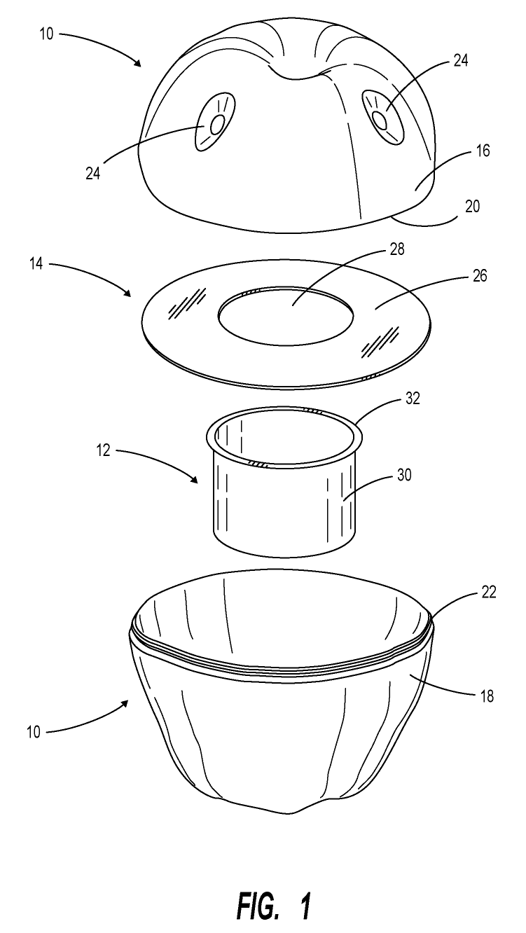

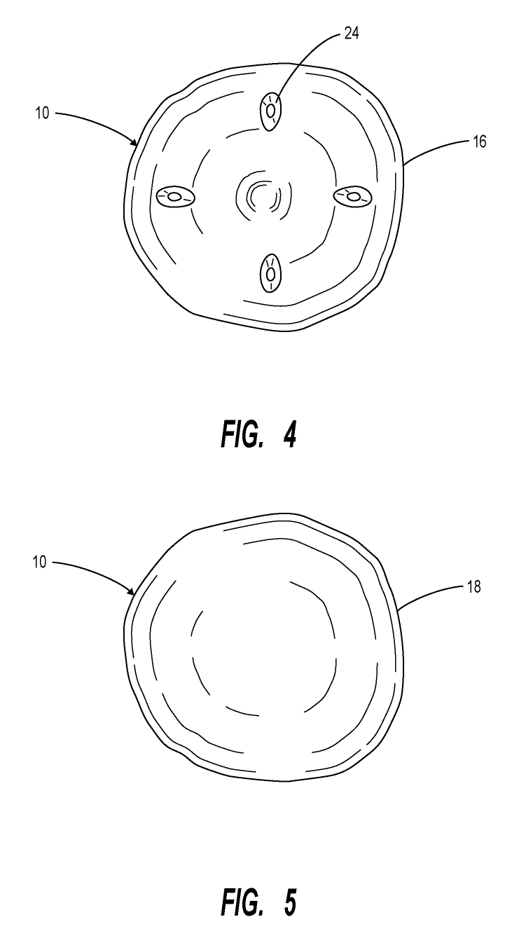

The trap of the present invention includes a trap housing 10, an attractant 12, and a disabling means 14. FIGS. 1-5 show various viewpoints of this device and components.

As shown in the drawings, the housing 10 is an integrally formed piece having a top cover portion 16 and a bottom base portion 18. These two portions may be joined together by a locking mechanism constituting a snap together design made possible by an annular lip 20 located around the perimeter of the top portion 16. This lip 20 may be releasably joined to a receiving ridge 22 located around the perimeter of the bottom portion 18. Other well-known and readily available locking mechanisms may alternatively be used to perform this function as well.

In general, the trap housing 10 is made of plastic, discrete, and well-disguised as a piece of fruit such as an apple, orange, banana or the like. The disguised appearance of the trap provides an aesthetically pleasing item as well as an effective means for capturing fruit flies. Adding to the device's discrete nature is its method of operation. Fruit flies and insects trapped by the device are generally confined to the inside chamber of the device as the disabling means is contained within the housing. Accordingly, trapped insects are hidden from view. Problems of a messy and unsightly trap are avoided in this way. Therefore, this device is able to be situated in an area where it will be most useful, even if the trap is readily in view, due to the present invention's attractive and discrete operation.

Shown in FIG. 1 is member 10 in an exploded, unassembled configuration. Thus, the various interior features of the device are readily seen. The top portion 16 is the outer wall of the fruit-like shape and has a plurality of small contoured entry holes 24 around its surface. These holes 24 are somewhat discrete and do not detract greatly from the overall aesthetically pleasing appearance of the fruit-shaped device. The interior of the top portion 16 largely forms an outer shell with a hollow interior.

Also seen in FIG. 1 is a flat disc 26 with a center hole 28 that may be set within the perimeter of the bottom portion 18 of the housing. This disc may be coated in a sticky substance like a glueboard or may have another fruit fly disabling mechanism, such as poison or insecticide for use as the disabling means 14 of the device. Suitable disabling means include, but are not limited to glue and/or a piece of cardboard covered with insecticide. Both glue and insecticide could be placed in the trap together to provide multiple modes for disabling fruit flies. Glueboards or other such devices of a variety of shapes and sizes may be used depending upon the particular trap design features. Further, some embodiments of this device may also place a disabling substance or material around the inside surfaces of the top and bottom interiors of the housing 10.

The center hole 28 in the disc 26 forms a passageway to the area inside the lower portion of the housing 18 in which a container 30 of attractant resides. This attractant container generally can be sealed prior to use and can be activated and opened when the user desires to begin using the fruit fly trap. The attractant container 30 may sit on the lower housing portion 18 such that the opening in the top of the attractant container is integrally aligned with the above hole 28 of disc 26 or the container 30 may optionally be lowered through the hole of disc 26 and held in place by the lip 32 circling the attractant container's upper perimeter. The type of attractant found within the device may be suited especially for fruit flies although the attractant used in this device is not limited solely to attractant used to catch fruit flies. Such attractants may include various natural product attractants, pheromones or odoriferous substances or items.

The bottom portion of the trap housing 18 generally forms an outer shell around a hollow interior similar to the top portion 16 of the housing. The top and bottom housing portions 16 and 18 snap integrally together to form one uniform and discrete fruit fly trap that is effectively disguised as a piece of fruit.

In general, fruit flies are attracted to enter the device through the openings 24 in the housing by the scent given off by attractant material located inside. When the fruit flies enter they generally become disabled and die due to the glue, insecticide, or combination found within the housing 10. Other fruit flies may die as they will not be able to find a means of escape from the interior of the housing. Since the fruit flies remain within the opaque walls of the housing after entry, the dead flies remain hidden from view. Also, because the trap can be easily opened by pulling apart the bottom and top portions of the housing to expose its internal features, the device can be readily cleaned out and new attractant material and disabling means can be added as required. The device can then be closed by aligning the top and bottom portions and snapping the attachment mechanism together. If the attractant material poses a significant safety threat to children or pets the top and bottom housing portions can be permanently sealed to prevent access to the disabling means.

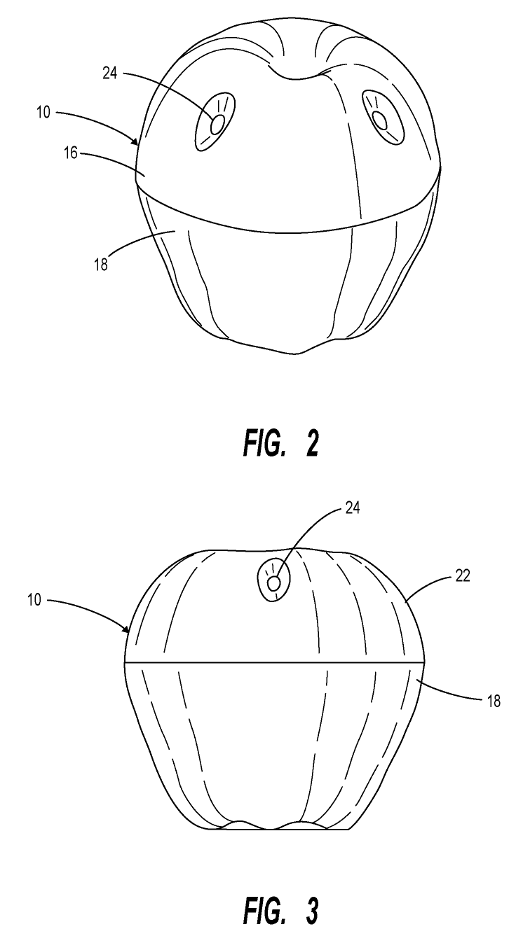

With respect to FIGS. 2-5, the external features of the present invention are set forth. The external design shown in these figures is important as it provides a device specifically suited for its purpose. This design includes aesthetically shaped corners of the top and bottom portion of the housing with openings 24, a well-balanced base of bottom housing portion 18, and a generally discrete profile.

Those skilled in the art will appreciate that the fruit fly trap of the present invention may be manufactured in a variety of shapes and sizes to accommodate various sizes and types of flies and insects. A number of different attractant materials or means of disablement may be utilized. The trap can be composed of plastic or similar suitable materials. Without limitation, the trap is generally of the size and shape of typical types and sizes of fruit. Due to the small size of this device the trap can be placed and utilized in any number of locations in which fruit flies live or are attracted. The insect trap of the present invention may be disguised as other shapes as well, including naturally occurring vegetables, or even small animals such as frogs or dragonflies without substantially departing from the teaching of the invention.

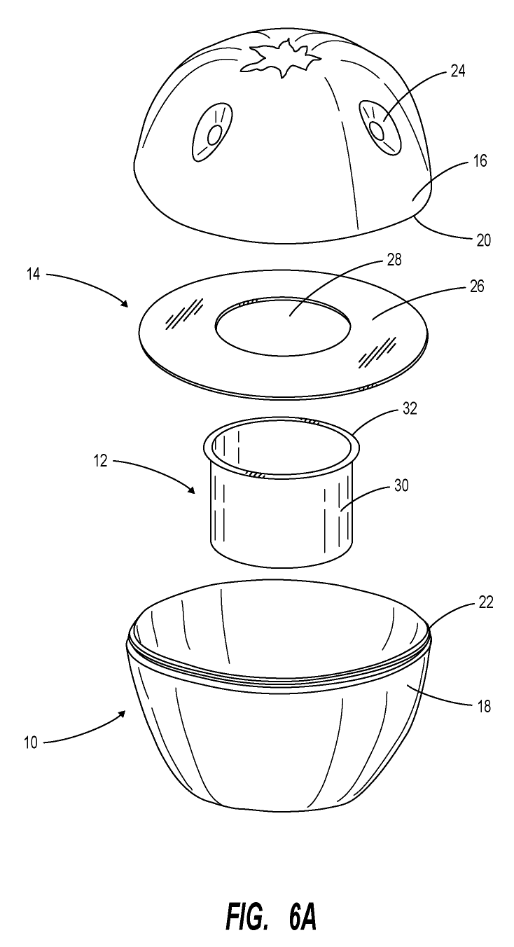

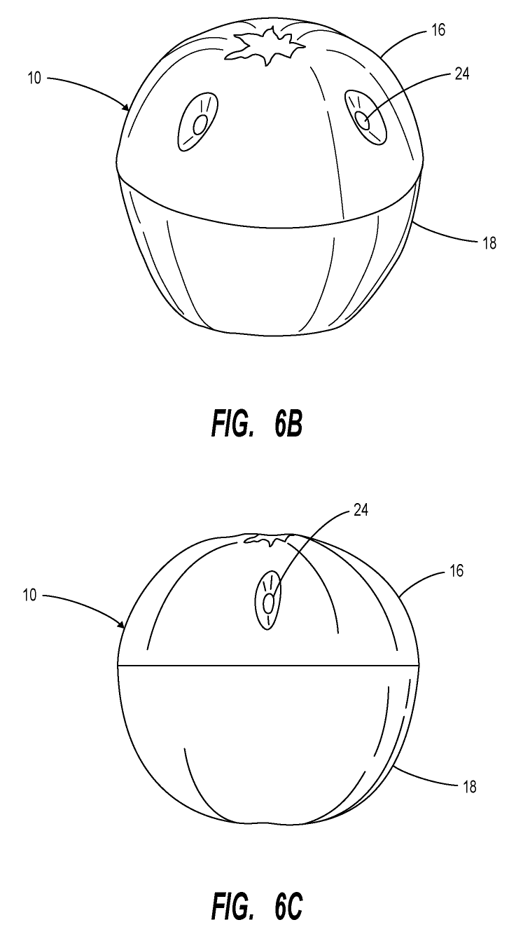

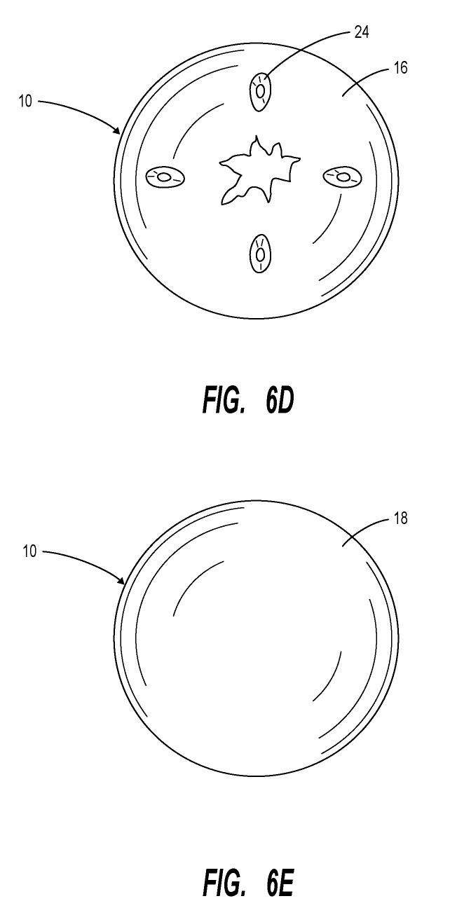

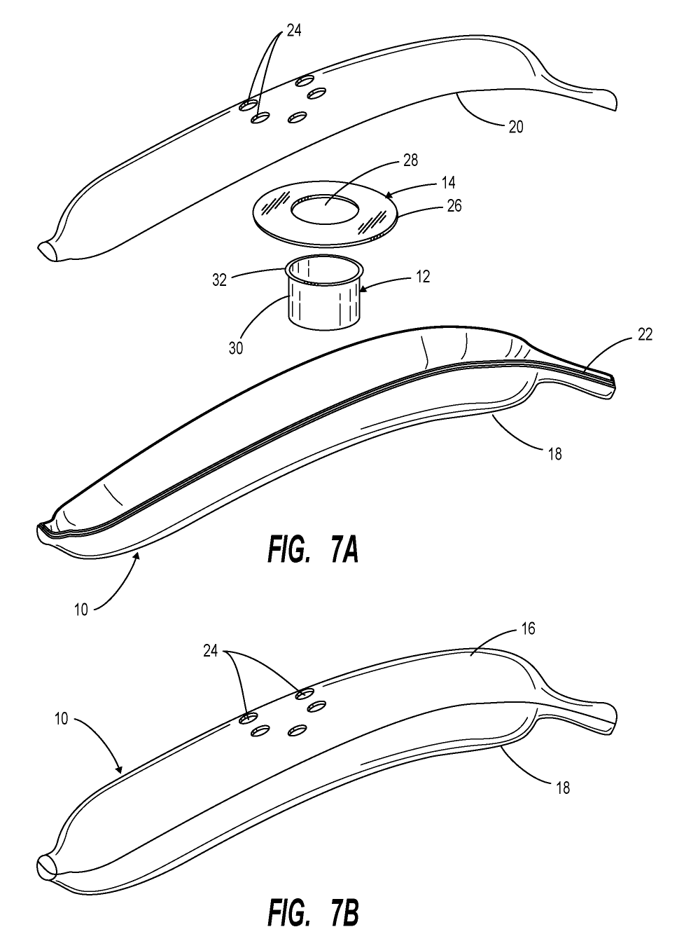

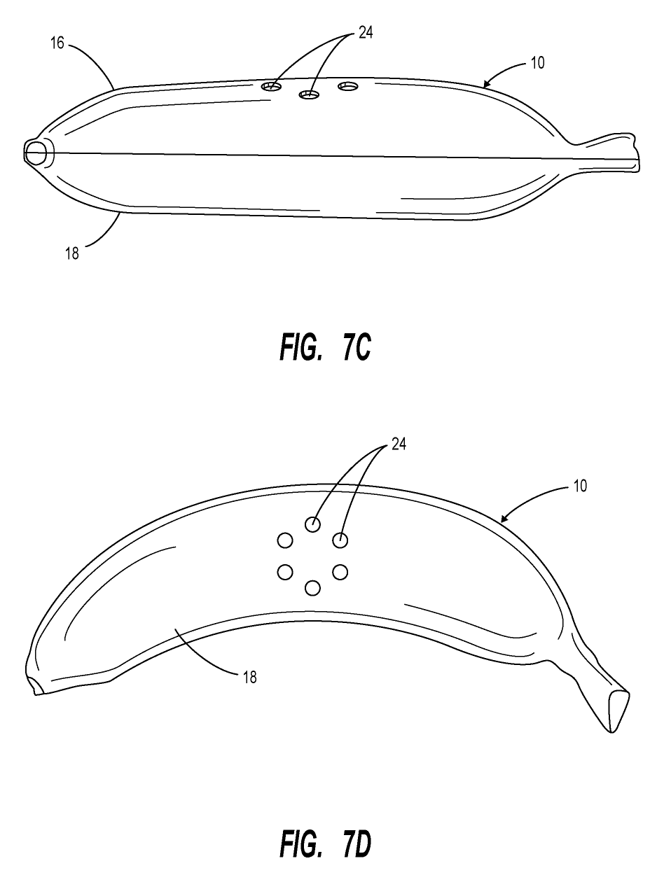

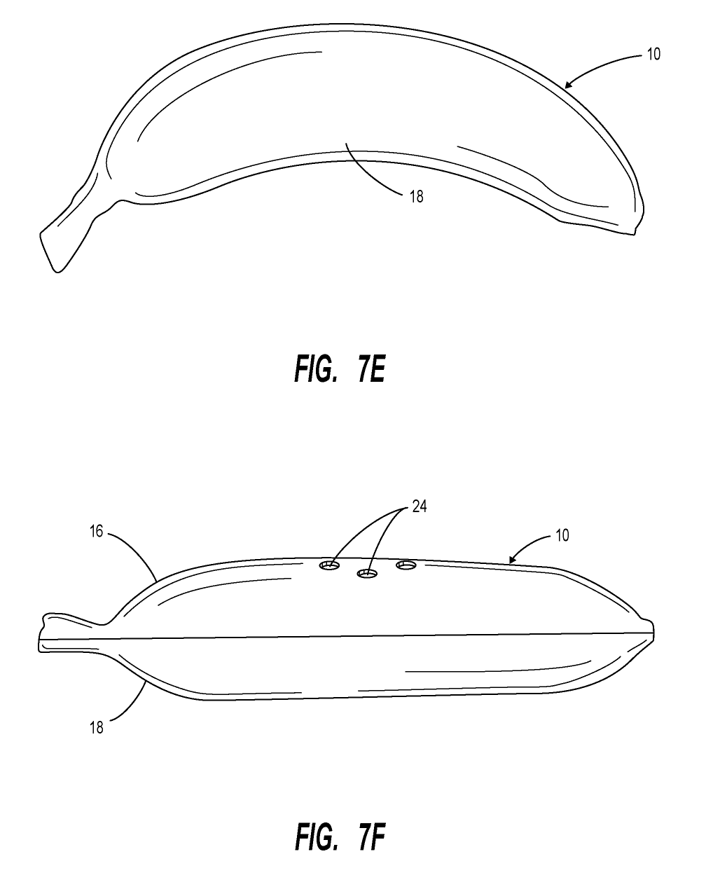

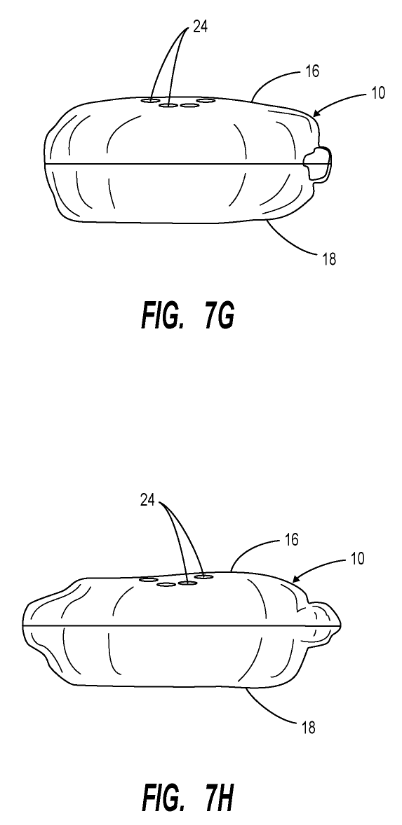

For example, FIGS. 6A-6E show an embodiment of the present invention where the shape of the housing is an orange. Further, FIGS. 7A-7H show an embodiment of the present invention where the shape of the housing is a banana. These embodiments operate in the same manner as the apple design seen in FIGS. 1-5 and contain corresponding and like parts.

Also, the design of the present invention should not be construed to limit its application to the capture and extermination of pests. The various fruit-shaped designs disclosed may also be used in hunting applications to attract deer or other wild game. In such applications, various types of attractant may be used within the design including solids, liquids or gels. Yet another application for the fruit shaped device is an air freshener for home use. The well disguised fruit shape enables such a device to be discretely and effectively utilized to stop or cover up unwanted odors.

The invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

1. An insect trap comprising:
(a) a fruit-shaped housing providing an interior chamber for retaining lured insects and one or more access openings leading to the interior chamber of the housing;
(b) an insect disabling mechanism located within the housing; and
(c) an insect attractant located within the housing.

2. The insect trap as in claim 1 wherein the housing can be physically separated into a top portion and a bottom portion.

3. The insect trap as in claim 2 wherein the top portion and the bottom portion snap together using a locking mechanism.

4. The insect trap as in claim 1 wherein the disabling mechanism is a glueboard.

5. The insect trap as in claim 1 wherein the attractant is a liquid or a powder.

6. The insect trap as in claim 5 and further including a container within the housing in which attractant is located.

7. The insect trap as in claim 1 wherein the disabling means comprises a coating of sticky or insecticide material on the interior surfaces of the housing.

8. A fruit fly trap comprising:
(a) a housing disguised as a piece of naturally occurring fruit, vegetable, or small animal which contains a plurality of apertures providing passages to the interior of the housing through which fruit flies are lured into the housing;
(b) a glueboard with a central aperture located within the housing; and
(c) a container of insect attractant located within the housing adjacent the glueboard.

9. The fruit fly trap as in claim 8 wherein the insect attractant is made up of pheromones or odoriferous attractants.

10. The fruit fly trap as in claim 8 wherein the housing may be opened for cleaning and replacing the glueboard and attractant.

11. The fruit fly trap as in claim 8 wherein the trap housing may be sealed shut.
